(19) United States
(12) Patent Application Publication
(10) Pub. No.: US 2024/0109788 A1
(43) Pub. Date: Apr. 4, 2024

(54) ATMOSPHERIC PLASMA SYNTHESIS OF TRANSITION METAL OXIDE CATHODES

(71) Applicant: Alliance for Sustainable Energy, LLC, Golden, CO (US)

(72) Inventors: Ryan Ray BROW, Denver, CO (US); Shriram SANTHANAGOPALAN, Sylvania, OH (US); Chaiwat ENGTRAKUL, Louisville, CO (US)

(21) Appl. No.: 18/478,119

(22) Filed: Sep. 29, 2023

Related U.S. Application Data
(60) Provisional application No. 63/377,778, filed on Sep. 30, 2022.

(51) Int. Cl. C01G 53/00; B01J 19/08; B01J 19/10; B01J 19/24; H01M 10/0525

(52) U.S. Cl. CPC C01G 53/44; B01J 19/087; B01J 19/088; B01J 19/10; B01J 19/2415; H01M 10/0525; C01P 2002/74; C01P 2002/85; C01P 2004/03

(57) ABSTRACT

An atmospheric microplasma process is used to synthesize cathode particles in less than approximately one second. A hollow-tube reactor may be used to create cathode particles that are in the range of approximately 0.1 μm to approximately 3 μm in diameter, are at least partially crystalline, and show redox behavior expected of a transition metal oxide cathode material.

### CROSS-REFERENCE TO RELATED APPLICATIONS

This application claims priority to U.S. Provisional Patent Application No. 63/377,778 filed on Sep. 30, 2022, the contents of which are incorporated herein by reference in their entirety.

### CONTRACTUAL ORIGIN

This invention was made with United States government support under Contract No. DE-AC36-08G028308 awarded by the U.S. Department of Energy. The United States government has certain rights in this invention.

### BACKGROUND

Conventional synthesis of lithium-ion battery cathodes at the industrial scale involves mixing of precursors, followed by extensive heat treatment that accounts for nearly 90% of the energy consumption in cell manufacturing. A typical synthesis routine for the manufacture of transition metal oxide cathodes (such as lithium nickel manganese (NMC) cathodes) uses co-precipitation, in which, a liquid solution of metal hydroxides or metal sulfates are continuously stirred above about 50° C. and pH greater than about 10 in a controlled atmosphere. The metal hydroxide precipitate is collected, mixed with a lithium source and calcined at temperatures greater than about 700° C. Thus, there remains a need for a way to synthesize transition metal oxide cathodes that is more energy efficient.

### SUMMARY

An aspect of the present disclosure is a method of creating a plurality of NMC-type cathode particles, the method includes preparing a precursor solution, positioning an anode and a cathode in a reactor vessel, applying a current to the anode and the cathode, and supplying the precursor solution to the reactor vessel, in which the supplying results in the plurality of NMC-type cathode particles. In some embodiments, the preparing includes combining a carrier gas with a liquid precursor to form an initial precursor solution, vaporizing the initial precursor solution to form the precursor solution, and ionizing the precursor solution. In some embodiments, the carrier gas includes at least one of argon, oxygen, helium, or nitrogen. In some embodiments, the liquid precursor includes a colloidal solution, a chelating agent, and a lithium source. In some embodiments, the colloidal solution includes a mixture of nickel, cobalt, and manganese acetate hydrates. In some embodiments, the chelating agent includes at least one of citric acid, acetic acid, oxalic acid, or ethylenediaminetetraacetic acid (EDTA). In some embodiments, the lithium source includes at least one of lithium hydroxide hydrate or lithium carbonate. In some embodiments, the vaporizing includes using at least one of a sonicator, nebulizer, or vibrating transducer. In some embodiments, the ionizing includes exposing the precursor solution to an inert gas at a flow rate. In some embodiments, the inert gas includes at least one of argon, helium, neon, or xenon. In some embodiments, the flow rate is within the range of about 10 sccm to about 60 sccm. In some embodiments, the positioning includes placing the anode and the cathode in a hollow tube reactor; and the positioning results in the anode and the cathode being separated by a distance in the range of about 0.1 mm to about 5 mm. In some embodiments, the hollow tube reactor is a quartz tube. In some embodiments, the anode and the cathode comprise at least one of stainless steel, nickel, or cobalt. In some embodiments, the cathode has an inner diameter in the range of about 0.01 mm to about 3 mm, and the anode has an inner diameter in the range of about 0.001 mm to about 5 mm. In some embodiments, the current includes an alternating current. In some embodiments, the alternating current includes approximately 250 W and approximately 25 kHz. In some embodiment the alternating current results in a potential of approximately 3 kV between the anode and cathode. In some embodiments, the supplying includes a flow rate in the range of about 1 to about 200 sccm.

An aspect of the present disclosure is a system for creating NMC-type cathode particles, the device includes a chamber arranged to contain an initial precursor solution, a nebulizer arranged to vaporize the initial precursor solution to form a precursor solution, an anode and a cathode positioned within a reactor vessel, and a power source arranged to apply a current to the anode and cathode, in which the reactor vessel includes a hollow tube reactor, and the precursor solution is directed into the reactor vessel. In some embodiments, the initial precursor solution includes a carrier gas and a liquid precursor. In some embodiments, the carrier gas includes at least one of argon, oxygen, helium, or nitrogen, and the liquid precursor includes a colloidal solution, a chelating agent, and a lithium source. In some embodiments, the colloidal solution includes a mixture of nickel, cobalt, and manganese acetate hydrates. In some embodiments, the chelating agent includes at least one of citric acid, acetic acid, oxalic acid, or ethylenediaminetetraacetic acid (EDTA). In some embodiments, the lithium source includes at least one of lithium hydroxide hydrate or lithium carbonate. In some embodiments, the nebulizer includes a sonicator or vibrating transducer. In some embodiments, the anode and the cathode are separated by a distance in the range of about 0.1 mm to about 5 mm. In some embodiments, the hollow tube reactor includes a quartz tube. In some embodiments, the anode and the cathode include at least one of stainless steel, nickel, or cobalt. In some embodiments, the cathode has an inner diameter in the range of 0.01 mm to about 3 mm, and the anode has an inner diameter in the range of about 0.001 mm to about 5 mm. In some embodiments, the current includes an alternating current. In some embodiments, the alternating current includes approximately 250 W and approximately 25 kHz. In some embodiments, the system includes a potential of approximately 3 kV between the anode and cathode.

### BRIEF DESCRIPTION OF THE DRAWINGS

Some embodiments of the present disclosure are illustrated in the referenced figures of the drawings. It is intended that the embodiments and figures disclosed herein are to be considered illustrative rather than limiting.

FIG. 1 illustrates a schematic of a system including a microplasma reactor for synthesizing lithium nickel manganese (NMC) cathode particles, according to some aspects of the present disclosure.

FIG. 2 illustrates a method of creating a plurality of NMC-type cathode particles, according to some aspects of the present disclosure.

FIG. 3 illustrates an initial direct current (DC) hollow-tube reactor for generating microplasma, according to some aspects of the present disclosure.

FIGS. 4A-D illustrates scanning electron microscopy (SEM) images showing size (FIG. 4A), surface morphology (FIG. 4B), distribution (FIG. 4C) of microplasma reaction products, and (FIG. 4D) unreacted precursor vapor can be seen in the dashed circle, according to some aspects of the present disclosure.

FIG. 5 illustrates shows energy dispersive X-ray spectroscopy (EDX) spectra of a region containing a cathode particle (image “d” panel A) and no cathode particle (image “d” panel B), according to some aspects of the present disclosure.

FIG. 6 illustrates X-ray diffraction data from Cu-kα source with reaction products collected on a silicon zero background substrate, according to some aspects of the present disclosure.

FIGS. 7A-D illustrates cyclic voltammetry of reaction products collected during arc-like plasma discharge and a glow-type plasma discharge, according to some aspects of the present disclosure. FIG. 7A illustrates cyclic voltammetry of reaction products collected during arc-like plasma discharge showing iron redox behavior. FIG. 7B illustrates cyclic voltammetry of reaction products collected during arc-like plasma discharge for small nickel redox behavior. FIG. 7C illustrates reaction products collected without a glow-type plasma discharge. FIG. 7D illustrates reaction products collected with a glow-type plasma discharge.

### REFERENCE NUMERALS

100 . . . system for creating NMC-type cathode particles

105 . . . chamber

107 . . . precursor solution

110 . . . nebulizer

115 . . . anode

120 . . . cathode

125 . . . reactor vessel

130 . . . hollow tube reactor

135 . . . power source

137 . . . current

140 . . . carrier gas tanks

142 . . . carrier gas

145 . . . liquid precursor

147 . . . tube

150 . . . initial precursor solution

155 . . . cathode particles

157 . . . plasma discharge

200 . . . method for creating a plurality of NMC

205 . . . preparing

210 . . . positioning

### DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

As used herein “plasma” refers to the fourth state of matter a mixture of fully or partially ionized gas. In plasma there may be a significant portion of charged particles in any combination of ions or electrons, as well as some neutral particles. As used herein “microplasma” refers to plasma confined within sub-millimeter length scale in at least one dimension. Microplasma is a type of plasma in which the dimensions of the plasma are in the millimeter and smaller range.

As used herein “plasma synthesis” involves the use of localized, high-energy plasma and/or microplasma discharges to induce chemical reactions and manipulate the growth of materials. Plasma synthesis may be used to synthesize a wide range of metal nanoparticles (including nickel, silicon, gold, iron, and platinum) and metal oxide nanoparticles (including nickel oxide, zinc oxide, and silicon dioxide) using a variety of techniques: plasma-enhanced chemical vapor deposition, dielectric barrier discharge, plasma jet, and in/on-solution plasma.

The manufacture of battery cathode materials is the most energy intensive step in the production of commercial lithium-ions batteries; specifically, the synthesis of the widely used transition metal oxide cathodes can take tens of hours at temperatures greater than approximately 700° C. Attempts at limiting the reaction time and energy required to form crystalline materials often still include a calcining step. In the present disclosure, a relatively simple atmospheric microplasma process is used to synthesize cathode particles in less than approximately one second. In some embodiments, a hollow-tube reactor used creates particles that are in the range of approximately 0.1 μm to approximately 3 μm in diameter, are at least partially crystalline, and show redox behavior expected of a transition metal oxide cathode material.

Among other things, the present disclosure relates to an atmospheric microplasma process used to synthesize NMC-type cathode particles. A hollow-tube reactor system produces spherical NMC-type particles that vary in diameter in the range of approximately 0.1 μm to approximately 3 μm. The cathode particles may have a relatively featureless spherical morphology as shown in SEM and have XRD patterns consistent with the layered structure of NMC-type cathodes. Cathode particles may also exhibit expected redox activity when placed into a coin cell versus Li. Although the microplasma synthesis method described herein demonstrated inconsistent plasma discharge, there is substantial evidence that NMC-type cathode materials were, in fact, synthesized.

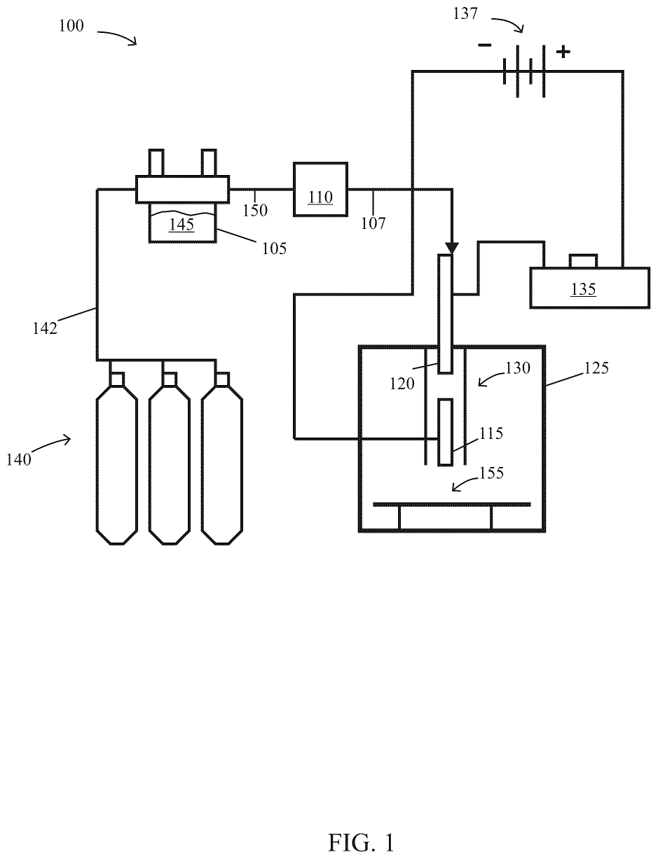

In some embodiments, a system 100 for creating NMC-type cathode particles 155 as shown in FIG. 1, may be used. The system 100 may include at least one chamber 105 to hold the initial precursor solution 150, a nebulizer 110 (or sonicator) to vaporize the initial precursor solution 150, an anode 115 and a cathode 120 positioned within a reactor vessel 125, and a power source 135 for applying a current 137 to the anode 115 and cathode 120. At least one carrier gas tank 140 may be used to store a carrier gas, which can be combined with a liquid precursor 145 to form an initial precursor solution 150. In some embodiments, a carrier gas tank 140 may be a metal cylinder containing a carrier gas 142 at a substantially high pressure.

In some embodiments, the system 100 may include a fluid-bed (not shown in FIG. 1) to entrain the initial precursor solution 150 in an inert gas (i.e., a carrier gas 142) through a quartz hollow tube reactor 130 in which plasma may be generated from an induction coil (not shown in FIG. 1). The relatively small-diameter of the reactor vessel 125, substantially uniform heating to a desired temperature and a targeted supply of lithium from a lithium source all aim to substantially minimize the energy footprint for the process. A power source 135 providing approximately 6 kVA, may be connected to the reactor vessel 125.

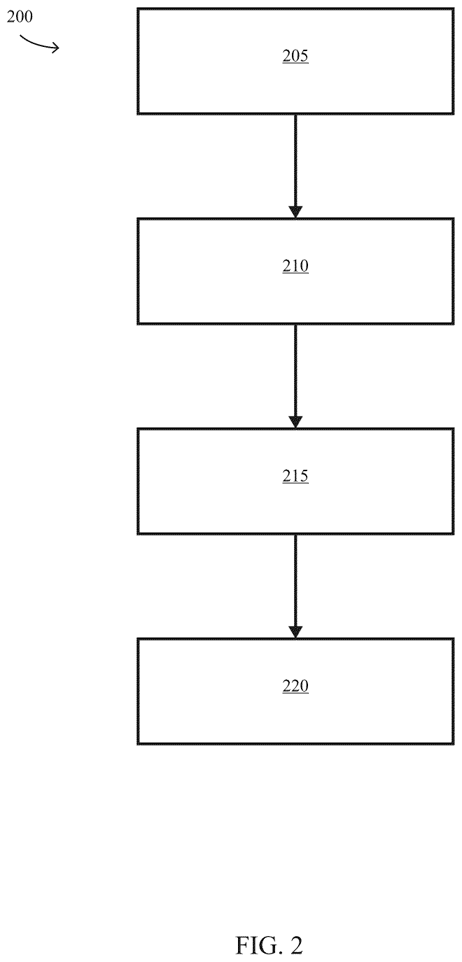

A method 200 for creating NMC-type cathode particles 155 is shown in FIG. 2. The method 200 may utilize the system 100 as shown in FIG. 1. In some embodiments, a method 200 for creating a plurality of NMC-type cathode particles 155 may first include preparing 205 a precursor solution 107. This preparing 205 may include combining a carrier gas 142 with a liquid precursor 145 to form an initial precursor solution 150, then vaporizing that initial precursor solution 150 (using a nebulizer 110, sonicator, or vibrating transducer) to form the precursor solution 107, then ionizing that precursor solution 107. In some embodiments, the carrier gas 142 may be at least one of argon, oxygen, helium, or nitrogen. In some embodiments, the liquid precursor 145 may include a colloidal solution, a chelating agent, and a lithium source. In some embodiments, the colloidal solution may be a mixture of nickel, cobalt, and manganese acetate hydrates. In some embodiments, the chelating agent may be at least one of citric acid, acetic acid, oxalic acid, or ethylenediaminetetraacetic acid (EDTA). In some embodiments, the lithium source may be at least one of lithium hydroxide or lithium carbonate. In some embodiments, the ionizing may include exposing the precursor solution 107 to an inert gas at a rate in the range of about 10 sccm to about 60 sccm. In some embodiments, the inert gas may be at least one of argon, helium, neon, or xenon.

In some embodiments, the method 200 may next include positioning 210 an anode 115 and a cathode 120 in a reactor vessel 125. In some embodiments, this may include placing the anode 115 and the cathode 120 in the reactor vessel 125. In some embodiments, the reactor vessel 125 may be a hollow tube reactor 130. In some embodiments, the anode 115 and the cathode 120 may be separated by a distance in the range of about 0.1 mm to about 5 mm. In some embodiments, the anode 115 and/or the cathode 120 may be made of at least one of stainless steel, nickel, or cobalt. In some embodiments, the anode 115 may have an inner diameter (ID) in the range of about 0.001 mm to about 5 mm and the cathode 120 may have an ID in the range of about 0.01 mm to about 3 mm. In some embodiments, the hollow tube reactor 130 may be a quartz tube.

In some embodiments, the method 200 may next include applying 215 a current 137 to the anode 115 and the cathode 120. In some embodiments, the current 137 may be either alternating current or direct current. In some embodiments, the current 137 may result in a potential of approximately 3 kV between the anode 115 and the cathode 120. In some embodiments, the current 137 may be approximately 250 W and approximately 25 kHz.

In some embodiments, the method 200 may next include supplying 220 the precursor solution 107 to the reactor vessel 125, resulting in a plurality of NMC-type cathode particles 155. The supplying 220 may be done at a flow rate in the range of approximately 1 sccm to about 200 sccm. In some embodiments, the reactor vessel 125 may be a chamber or container used for plasma reactions. To allow the reaction to occur at atmospheric pressure, the reactor vessel 125 may not be vacuum sealed. Not requiring the method 200 to be performed in a vacuum may significantly reduce the energy needed to synthesize cathode particles 155.

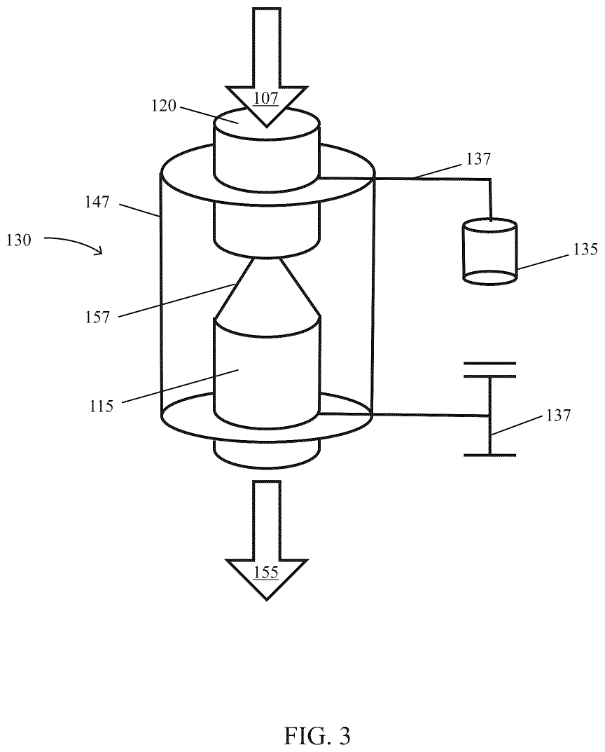

In some embodiments, a hollow-tube reactor (as shown in FIG. 3) may be used to synthesize NMC cathode particles 155 via a one-step atmospheric microplasma route. A precursor vapor made of a plasma gas and a carrier gas may be combined with a liquid precursor to form an initial precursor solution. Argon and oxygen gases may be both the plasma gas and the carrier gas of the precursor vapor. The sol of a sol-gel-type NMC synthesis may be the liquid precursor. Sol-gel may be a wet-chemical process that involves the formation of a colloidal suspension (sol) and gelation of the sol in a relatively continuous liquid phase (gel) to form a network structure. For example, the sol may contain a 0.3M mixture of nickel, cobalt, and manganese acetate hydrates with a stoichiometry of Ni₅Co₃Mn₂. A colloidal solution, a chelating agent, and a lithium source may be combined to form a liquid precursor.

In some embodiments, citric acid may be used as a chelating agent and lithium hydroxide hydrate may be used as the lithium source yielding a total solution composition of Li_{1.1}Ni_{0.5}Mn_{0.3}Co_{0.2} in deionized (DI) water. The liquid precursor solution may be vaporized at room temperature (RT) using a sonicator or nebulizer 110 into a vapor chamber where it may then be carried by argon gas into the reactor vessel 125. An approximately 250 W, 25 kHz power supply from a power source 135 may then be used to provide approximately 3 kV between the cathode 120 and anode 115 electrodes (FIG. 1) that were spaced approximately 1.5 mm apart. A ballast resistor (approximately 500 kΩ) and potentiometer (in the range of approximately 0-100M) may be utilized to limit current (not shown in FIG. 1). In some embodiments, a stainless-steel cathode 120 (approximately 1 mm inner diameter (ID)) and anode 115 (approximately 1.5 mm (ID)) may be held in a hollow tube reactor 130 (e.g., a quartz tube) with a variable in the range of approximately 0-3 mm spacing between them. In the data shown herein, samples were collected at the base of the anode 115 electrode. To ignite a plasma, an argon gas flow rate of 30 sccm may be used. The precursor vapor may then be slowly introduced and held at a final rate (in the range of approximately 10-100 sccm).

FIG. 1 illustrates a schematic of system 100 including a microplasma reactor vessel 125 for synthesizing transition metal cathode particles 155, according to some aspects of the present disclosure. The system 100 utilizes microplasma reactor vessel 125 for synthesis of lithium nickel manganese (NMC) cathode materials 155. The microplasma may be generated in a quartz hollow tube reactor 130 (having a diameter of less than approximately 1.0 mm) at substantially atmospheric pressure using either an alternating current (AC) or direct current (DC) field generated by a power source 135. The precursor solution 107 (i.e., a solution containing metal acetate hydrates) may be vaporized with a nebulizer 110 and carried by a mix of inert gases. The carrier gases may be argon (Ar), helium (He), and/or oxygen (O₂).

FIG. 3 illustrates an initial direct current (DC) hollow-tube reactor 130 for generating microplasma, according to some aspects of the present disclosure. The hollow-tube reactor 130 may include a cathode 120 and an anode 115 contained within a tube 147. Plasma discharge 157 may be located between the cathode 120 and the anode 115. A power source 135 may supply current 137 to both the cathode 120 and the anode 115. In some embodiments, tube 147 may be a quartz tube. In some embodiments, additional tubing, such as nickel tubing, may be present inside tube 147.

In some embodiments, a solid-gel precursor solution 107 may be fed into reactor vessel 125 using a precursor vapor inlet (not shown in FIG. 3). There may be a glow discharge and/or abnormal/glow-to-arc precursor plasma during plasma discharge 157. In some embodiments, the plasma discharge 157 may be bright, neon, pink or purple.

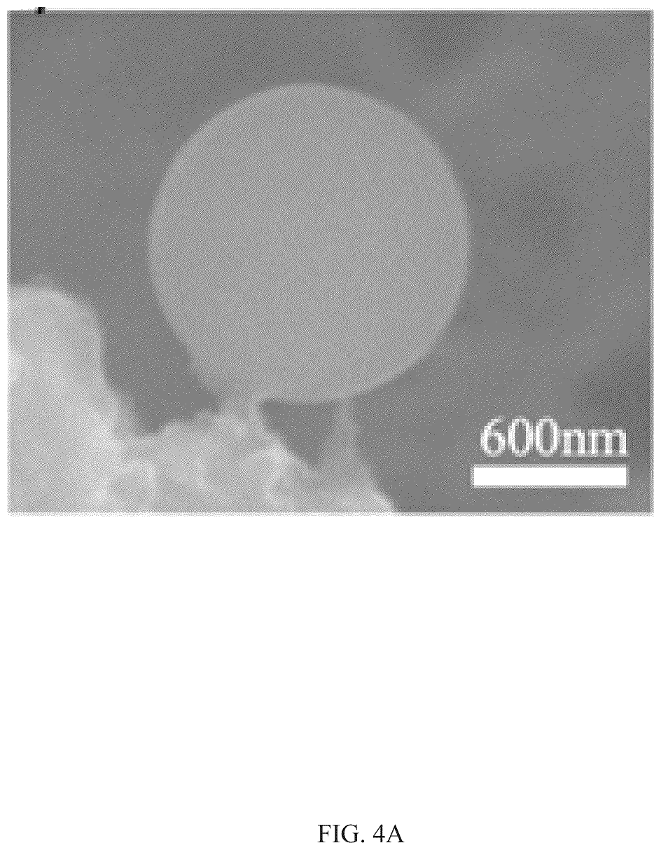

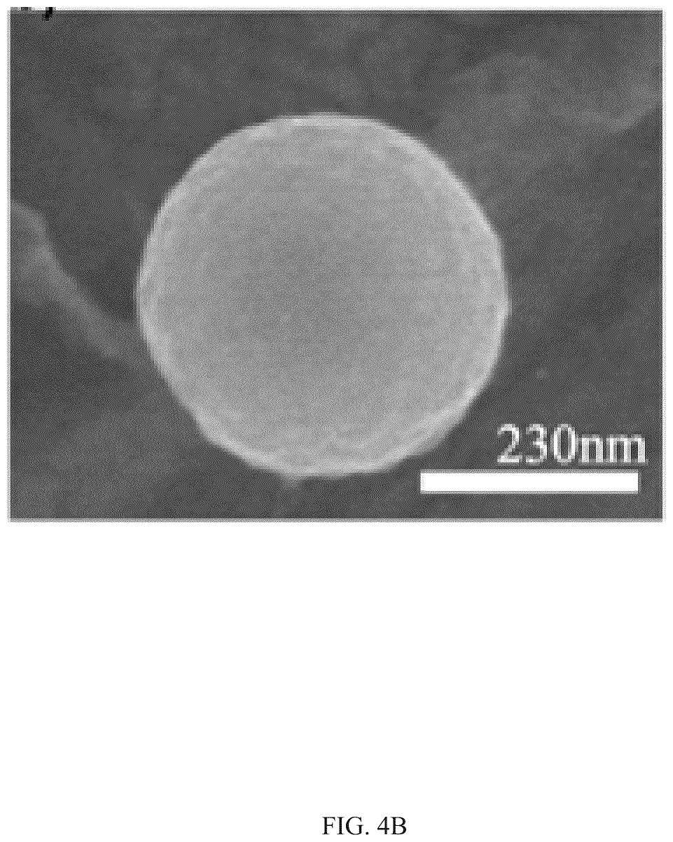

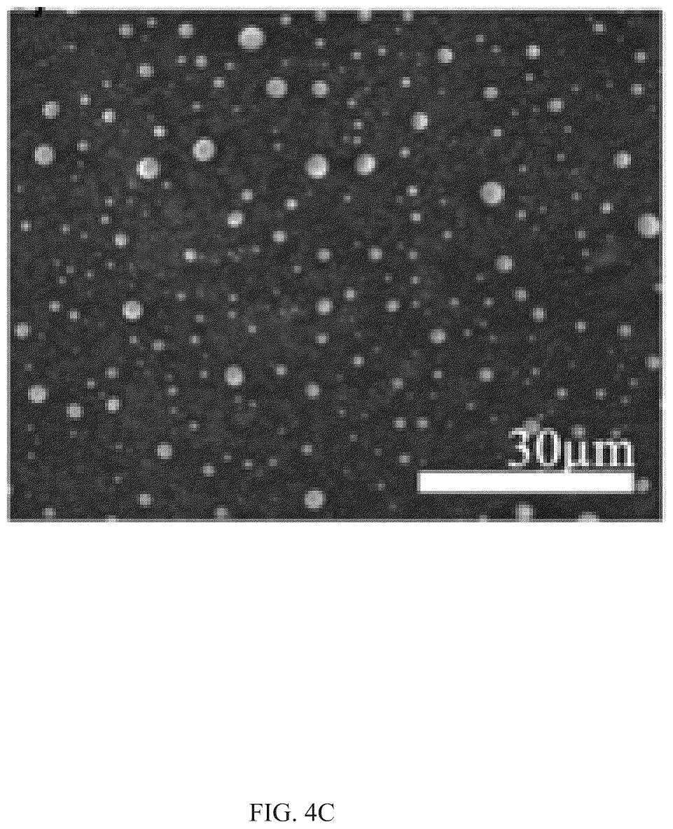

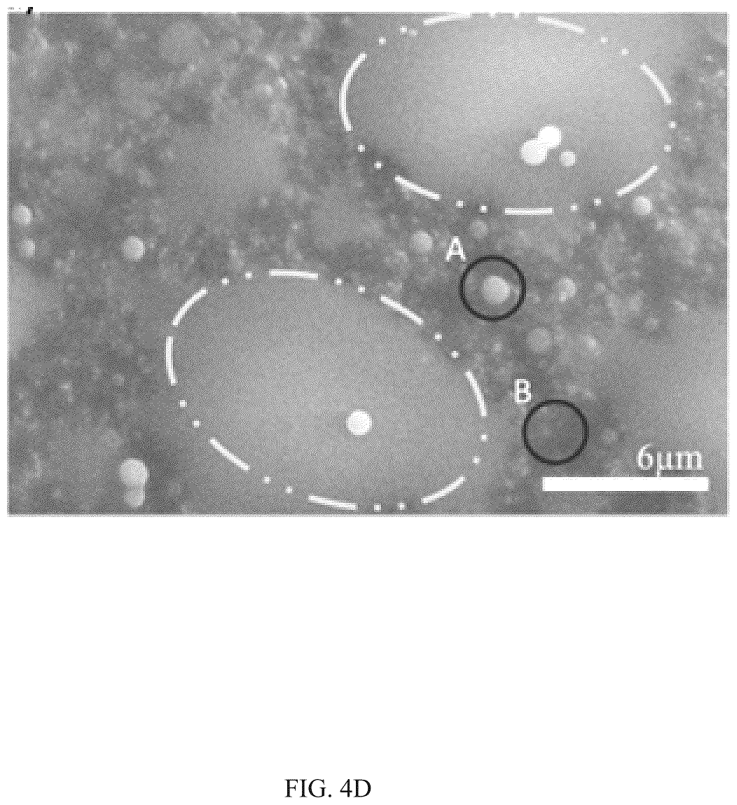

Scanning electron microscopy was used to visualize the micro-sized synthesis products collected at the base of anode 115. The results are shown in FIGS. 4A-D. Substantially evenly distributed, spherical cathode particles 155 can be seen with particle diameters varying between approximately 0.1-3 μm (FIGS. 4A-C). The large size of at least some of the cathode particles 155 suggests an advantage for the method of atmospheric microplasma: namely, atmospheric microplasma yields cathode particles 155 sizes much larger than that typically produced using low/mid-range vacuum plasmas. The cathode particles 115 synthesized via microplasma seem to have a substantially featureless surface. This is unlike cathode particles 115 synthesized by the traditional calcination process, which are large agglomerations of loosely bound primary particles. Additionally, the spherical cathode particles 115 produced by microplasma synthesis are devoid of any obvious (001), (012) or (104) facets that would be expected of a single crystalline particle, suggesting the cathode particles 115 are polycrystalline. The smooth texture of the cathode particles 115 suggests that the particles reported here are made of smaller crystallites that are more tightly bound, fused or have been etched. This unique morphology may have important implications for rate capability and durability.

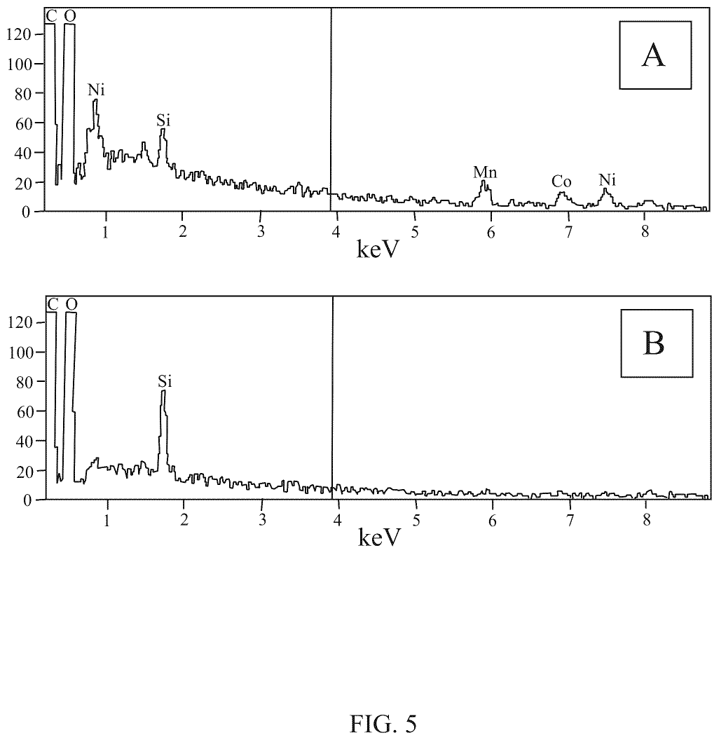

Basic elemental analysis was performed via energy-dispersive X-ray spectroscopy (results shown in FIG. 5). Conductive carbon tape was placed under reactor vessel 125 and allowed to collect cathode particles 155 for approximately 5 minutes. Two regions were examined, region A and region B (FIG. 5). Region A contained a spherical particle such as that shown in FIG. 5. Region B contained no particles. Region A contains the elements of interest: nickel, manganese and cobalt in the approximate stoichiometry (Ni₄Mn₃Co₃) of that found in the precursor solution 107 (Ni₅Mn₃Co₂). Region B contained no discernable amount of any transition metal. Interestingly, this sample contained what appeared to be an unreacted precursor that had dried into amorphous clumps on the substrate (indicated with circles in FIG. 4D).

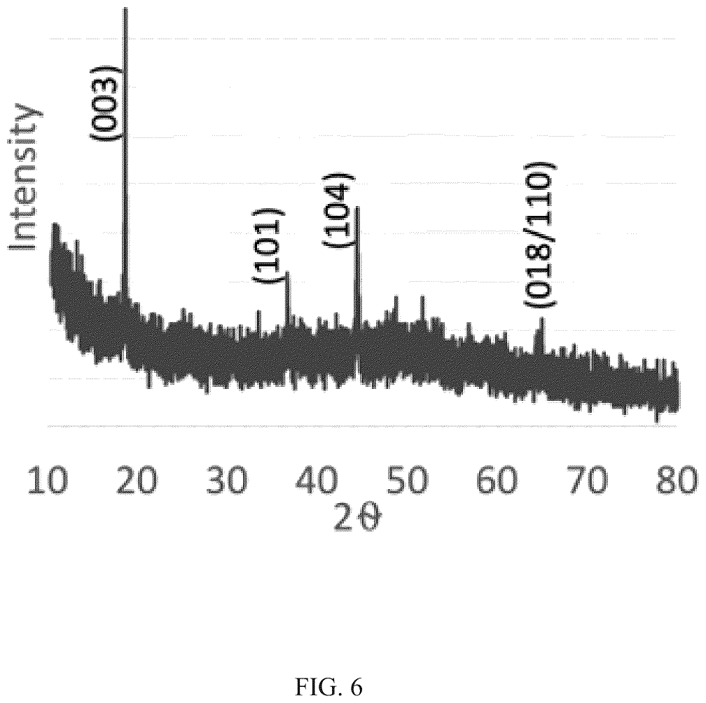

A silicon zero-background plate was placed under reactor vessel 125 for approximately 15 minutes and allowed to collect reaction products (i.e., cathode particles 155). The deposit had a milky-like color with no visible particles. The samples were placed into a Rigaku Smart lab system with a Cu-kα source (FIG. 6). While the degree of crystallinity of NMC-type cathode particles 155—generally determined from the splitting of the (018)/(110) and (006)/(012) peaks—is difficult to determine due to the low signal-to-noise ratio of the diffractogram (caused by the limited amount of material present), the presence of peaks at 18.7 and 44.5 2θ (the (003) and (104) peaks respectively) suggest that the cathode particles 115 are at least partially crystalline and have the expected hexagonal lattice structure with the R3m̅ space group. The cathode particles 155 also appear to be phase-pure as there are no peaks associated with metallic or metal-oxide nanoparticles or recrystallized lithium hydroxide. The broad peak centered at 50 2θ can be attributed to the silicon zero-background substrate, and the signal contains a large X-ray fluorescence from nickel. Unfortunately, the low signal-to-noise ratio (3:1) prevents accurate Rietveld refinement.

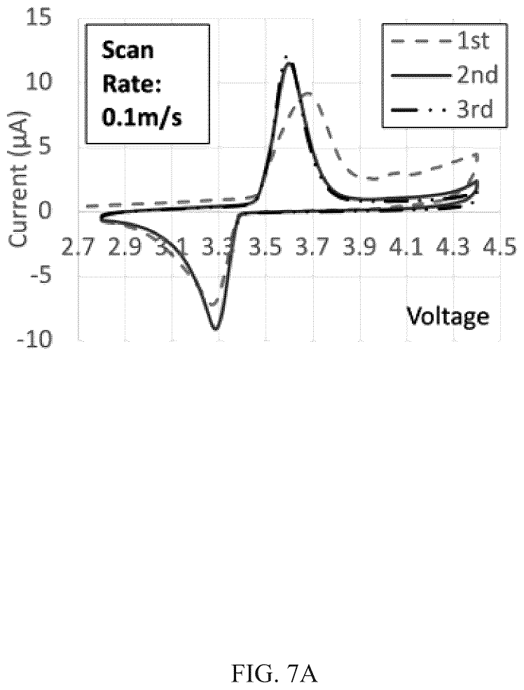

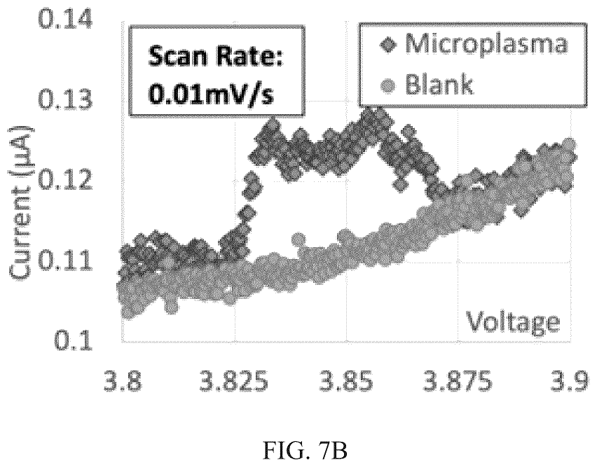

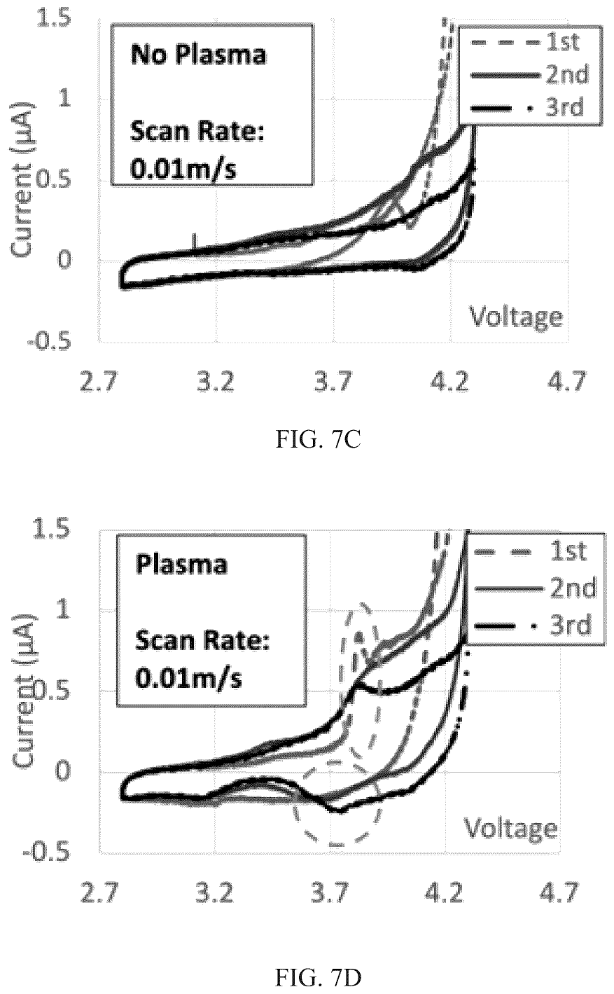

Cyclic voltammetry was used to determine the redox behavior of the cathode particles 155 synthesized via atmospheric microplasma. Small amounts of carbon black were placed under reactor vessel 125 for approximately 15 minutes, mixing the carbon black approximately every two minutes. Two different samples were prepared: one with the precursor solution 107 flowing through plasma (labeled as microplasma in FIG. 7B), and a control with the precursor solution 107 flowing but without plasma (labeled as blank in FIG. 7B). Each sample of carbon black was then slurry coated by mixing with polyvinylidene fluoride (PVDF) in N-methylpyrrolidone (NMP) and depositing onto aluminum foil using a doctor blade. The electrodes were dried in vacuum overnight and assembled into coin cells vs lithium metal and Gen-2 electrolyte (1.2 M LiPF₆ in 3:7 wt:wt ethylene carbonate: ethylmethyl carbonate).

For the sample flowing through plasma, parameters included a carrier gas of argon of approximately 25 sccm, a voltage from a power source 135 of approximately 3000 V, an approximately 1.5 mm gap between the anode 115 and the cathode 120, and an approximately 500 kΩ ballast resistor. It was difficult to maintain a glow discharge, and the plasma displayed a glow -to-arc discharge, as described previously, for most of the experiment. This may have caused large amounts of electrode sputtering as evidenced by the iron redox peak clearly visible in FIG. 7A. Iron^{2+/3+} has an anodic redox potential of approximately 3.6 V and cathodic potential of approximately 3.28 V at finite diffusion or substantially slow scan rates vs lithium. This peak masks that of nickel, so a slower anodic cyclic voltammetry scan was performed and scanned near the expected nickel potential (FIG. 7B). Here, redox from both the control cell (where the precursor vapor had not been processed in plasma) and the cell with plasma-processed products can both be seen. There is a clear anodic peak at the expected potential of nickel redox for this slow scan speed; suggesting that some quasi-reversible nickel-based redox was still occurring in the iron-rich sample. FIG. 7B illustrates current-voltage charts for microplasma reactants deposited on carbon black then assembled into a half-cell using a standard Gen-2 electrolyte, according to some aspects of the present disclosure.

To avoid the glow-to-arc type discharge and electrode sputtering above; additional variable resistance (in the range of approximately 0-100 kΩ) was added in serial with the ballast resistor. In this configuration, the plasma was struck with the variable resistor set to approximately 0 kΩ) and then the resistance was increased (typically by approximately 50 kΩ) until a plasma with a more glow-like discharge became visibly evident. Again, two samples of carbon black—one taken while the precursor solution 107 was flowing through the system but no plasma lit, and the other with precursor solution 107 flowing and the plasma lit—were placed underneath the reactor vessel 125 for 15 minutes and made into coin cells as stated above. The cyclic voltammetry of the two cells can be seen in FIGS. 4C-D. Here, the quasi-reversible nickel anodic/cathodic redox peaks are observed at approximately 3.85 V and approximately 3.7 V respectively (dashed circles shown in FIG. 7D). Their electrochemical quasi-reversibility, coupled with the X-ray diffraction peaks shown in FIG. 5, suggests NMC-type cathode particles 155 have been successfully formed.

The present disclosure includes a substantially one-step synthesis of a transition metal oxide-type cathode particles 155 has been accomplished via atmospheric microplasma. A hollow-tube reactor 130 was used to create NMC cathode particles 155 that display crystallinity and proper redox behavior. The microplasma may be generated at substantially atmospheric pressure, meaning the reaction need not occur in a vacuum. The current 137 used to generate the microplasma may be alternating or direct current.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A method of creating a plurality of NMC-type cathode particles, the method comprising:
preparing a precursor solution;
positioning an anode and a cathode in a reactor vessel;
applying a current to the anode and the cathode; and
supplying the precursor solution to the reactor vessel; wherein:
the supplying results in the plurality of NMC-type cathode particles.

2. The method of claim 1, wherein:
the preparing comprises:
combining a carrier gas with a liquid precursor to form an initial precursor solution;
vaporizing the initial precursor solution to form the precursor solution; and
ionizing the precursor solution.

3. The method of claim 2, wherein:
the carrier gas comprises at least one of argon, oxygen, helium, or nitrogen,
the liquid precursor comprises a colloidal solution, a chelating agent, and a lithium source,
the colloidal solution comprises a mixture of nickel, cobalt, and manganese acetate hydrates,
the chelating agent comprises at least one of citric acid, acetic acid, oxalic acid, or ethylenediaminetetraacetic acid (EDTA), and
the lithium source comprises at least one of lithium hydroxide hydrate or lithium carbonate.

4. The method of claim 2, wherein:
the vaporizing comprises using at least one of a sonicator, nebulizer, or vibrating transducer.

5. The method of claim 1, wherein:
the positioning comprises placing the anode and the cathode in a hollow tube reactor; and
the positioning results in the anode and the cathode being separated by a distance in the range of about 0.1 mm to about 5 mm.

6. The method of claim 1, wherein:
the current comprises an alternating current.

7. The method of claim 6, wherein:
the alternating current comprises approximately 250 W and approximately 25 kHz.

8. The method of claim 6, wherein:
the alternating current results in a potential of approximately 3 kV between the anode and cathode.

9. The method of claim 1, wherein:
the supplying comprises a flow rate in the range of about 1 to about 200 sccm.

10. A system for creating NMC-type cathode particles, the device comprising:
a chamber configured to contain an initial precursor solution;
a nebulizer configured to vaporize the initial precursor solution to form a precursor solution;
an anode and a cathode positioned within a reactor vessel; and
a power source configured to apply a current to the anode and cathode; wherein:
the reactor vessel comprises a hollow tube reactor, and
the precursor solution is directed into the reactor vessel.

11. The system of claim 10, wherein:
the initial precursor solution comprises a carrier gas and a liquid precursor.

12. The system of claim 11, wherein:
the carrier gas comprises at least one of argon, oxygen, helium, or nitrogen, and
the liquid precursor comprises a colloidal solution, a chelating agent, and a lithium source.

13. The system of claim 11, wherein:
the colloidal solution comprises a mixture of nickel, cobalt, and manganese acetate hydrates,
the chelating agent comprises at least one of citric acid, acetic acid, oxalic acid, or ethylenediaminetetraacetic acid (EDTA), and
the lithium source comprises at least one of lithium hydroxide hydrate or lithium carbonate.

14. The system of claim 10, wherein:
the nebulizer comprises a sonicator or vibrating transducer.

15. The system of claim 10, wherein:
the anode and the cathode are separated by a distance in the range of about 0.1 mm to about 5 mm.

16. The system of claim 10, wherein:
the hollow tube reactor comprises a quartz tube.

17. The system of claim 10, wherein:
the anode and the cathode comprise at least one of stainless steel, nickel, or cobalt.

18. The system of claim 10, wherein:
the cathode has an inner diameter in the range of 0.01 mm to about 3 mm, and
the anode has an inner diameter in the range of about 0.001 mm to about 5 mm.

19. The system of claim 10, wherein:
the current comprises an alternating current.

20. The system of claim 19, further comprising:
a potential of approximately 3 kV between the anode and cathode; wherein:
the alternating current comprises approximately 250 W and approximately 25 kHz.
